(19) United States
(12) Patent Application Publication
(10) Pub. No.: US 2012/0229086 A1
(43) Pub. Date: Sep. 13, 2012

(54) CHARGING APPARATUS OF MOBILE VEHICLE

(76) Inventors: Tse-Hua CHI, Taoyuan County (TW); Chang-Jyi SHEU, Taoyuan County (TW)

(21) Appl. No.: 13/100,648

(22) Filed: May 4, 2011

(30) Foreign Application Priority Data
Mar. 11, 2011 (TW) 100108236

(51) Int. Cl. H02J 7/00

(52) U.S. Cl. 320/109

(57) ABSTRACT

A charging apparatus of a mobile vehicle is provided to receive and convert an external alternating current (AC) power source into a direct current (DC) power source for charging a rechargeable battery of the mobile vehicle. The charging apparatus of the mobile vehicle includes a charging apparatus and the rechargeable battery. The charging apparatus is installed in the mobile vehicle. The charging apparatus includes an electromagnetic interference (EMI) filter and a power factor corrector (PFC). The EMI filter is provided to eliminate the noise in the AC power source to prevent the conductive electromagnetic interference. The PFC is provided to convert the filtered AC power source into the DC power source and improve the power factor of the converted DC power source. Therefore, the charging apparatus of the mobile vehicle provides power conversion and directly charges the rechargeable battery, thus reducing conversion losses and increasing charging efficiency.

### BACKGROUND OF THE INVENTION

1. Field of the Invention

The present invention relates generally to a charging apparatus, and more particularly to a charging apparatus of mobile vehicle.

2. Description of Prior Art

For today's technologies of driving mobile vehicles, that will be developed toward the trend of pollution-free and high-efficiency purposes. The battery is usually used to store the desired energy for the electric vehicles. In particular, the various generated energies, such as coal-fire energy, hydraulic energy, wind energy, thermal energy, solar energy, and nuclear energy, have to be converted into the electrical energy so that the electrical energy can be stored in the battery. However, the major issues of security, efficiency, and convenience have to be concerned during the energy conversion process.

Reference is made to FIG. 1 which is a block diagram of a prior art charging apparatus of a mobile vehicle. The mobile vehicle 100A includes a charting apparatus 10A and a rechargeable battery 20A. The mobile vehicle 100A can be an electric vehicle or an electric motorcycle, and the rechargeable battery 20A is a rechargeable battery of the electric vehicle or the electric motorcycle.

The charging apparatus 10A includes an electromagnetic interference filter 102A, a power factor corrector 104A, and a DC/DC converter 106A. The electromagnetic interference filter 102A of the charging apparatus 10A is electrically connected to an external AC power source Vs to eliminate the noise in the AC power source Vs, thus preventing the conductive electromagnetic interference. The power factor corrector 104A is electrically connected to the electromagnetic interference filter 102A to improve the power factor of the converted DC power source. The DC/DC converter 106A is electrically connected to the power factor corrector 104A to provide the required DC voltage level of charging the rechargeable battery.

However, the switching losses and the conduction losses are produced from the power switches (not shown) of the DC/DC converter 106A would reduce the whole charging efficiency of the charging apparatus of the mobile vehicle.

Actually, the charging apparatus 10A could be damaged due to the unnecessary collision when the charging apparatus 10A is installed inside the mobile vehicle 100A and the mobile vehicle 100A is driven on a bad road condition. In addition, the charging apparatus 10A could explode because of the high-temperature operation of the mobile vehicle 100A when the mobile vehicle 100A is driven or solarized for a long time. Furthermore, the charging apparatus 10A could cause an abnormal operation because of the accumulated dirt of the mobile vehicle 100A when the mobile vehicle 100A is used but not be cleaned for years. Accordingly, the life span of the charging apparatus 10A could reduce and even some one dies or gets hurt during driving when the charging apparatus 10A is operated under the above-mentioned bad conditions.

Accordingly, it is desirable to provide a charging apparatus of a mobile vehicle to reduce the losses of the power conversion, increase the charging efficiency, the flexibility and reliability, the life span of the charging apparatus, and increase the traffic safety of the mobile vehicle.

### SUMMARY OF THE INVENTION

In order to solve the above-mentioned problems, a charging apparatus of a mobile vehicle is disclosed. The charging apparatus of the mobile vehicle receives an external AC power source and converts the received AC power source into a DC power source for providing the required voltage to charge a rechargeable battery installed in the mobile vehicle. The charging apparatus is installed inside the mobile vehicle and the charging apparatus includes an electromagnetic interference filter and a power factor corrector.

The electromagnetic interference filter receives the AC power source to eliminate the noise in the AC power source to generate a filtered AC power source. The power factor corrector is electrically connected to the electromagnetic interference filter to convert the filtered AC power source into a DC power source and output the DC power source.

Therefore, the charging apparatus of the mobile vehicle provides a power conversion to directly provide a required DC charging voltage level to the rechargeable battery, thus reducing the losses of the power conversion and increasing the whole charging efficiency.

In order to solve the above-mentioned problems, a charging apparatus of a mobile vehicle is disclosed. The charging apparatus of the mobile vehicle receives an external AC power source, converts the received AC power source into a DC power source, and transfers a voltage level of the converted DC power source for providing the required voltage to charge a rechargeable battery installed in the mobile vehicle. The charging apparatus is installed outside the mobile vehicle and the charging apparatus includes an electromagnetic interference filter and a power factor corrector.

The electromagnetic interference filter receives the AC power source to eliminate the noise in the AC power source to generate a filtered AC power source. The power factor corrector is electrically connected to the electromagnetic interference filter to convert the filtered AC power source into a DC power source and output the DC power source.

Therefore, the charging apparatus is installed outside the mobile vehicle to increase the flexibility and reliability and to increase the life span of the charging apparatus.

In order to solve the above-mentioned problems, a charging apparatus of a mobile vehicle is disclosed. The charging apparatus of the mobile vehicle receives an AC power source filtered through an external electromagnetic interference filter, converts the filtered AC power source into a DC power source, and transfers a voltage level of the converted DC power source for providing the required voltage to charge a rechargeable battery installed in the mobile vehicle. The charging apparatus is installed inside the mobile vehicle and the charging apparatus includes a power factor corrector.

The power factor corrector converts the filtered AC power source filtered through the external electromagnetic interference filter and outputs the DC power source;

Therefore, the charging apparatus of the mobile vehicle provides a power conversion to directly provide the required DC charging voltage level to the rechargeable battery, thus reducing the losses of the power conversion and increasing the whole charging efficiency.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a block diagram of a prior art charging apparatus of a mobile vehicle;

FIG. 2 is a block diagram of a charging apparatus of a mobile vehicle according to a first embodiment of the present invention;

FIG. 3A is a block diagram of the charging apparatus of the mobile vehicle according to a second embodiment of the present invention;

FIG. 3B is a block diagram of the charging apparatus of the mobile vehicle according to a third embodiment of the present invention;

FIG. 3C is a block diagram of the charging apparatus of the mobile vehicle according to a fourth embodiment of the present invention;

FIG. 4A is a block diagram of the charging apparatus of the mobile vehicle according to a fifth embodiment of the present invention; and

FIG. 4B is a block diagram of the charging apparatus of the mobile vehicle according to a sixth embodiment of the present invention.

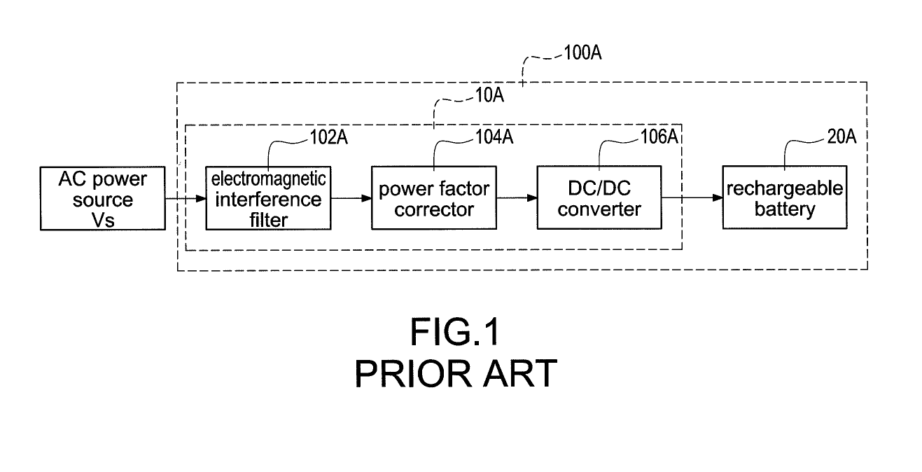

### DETAILED DESCRIPTION OF THE INVENTION

Reference will now be made to the drawing figures to describe the present invention in detail.

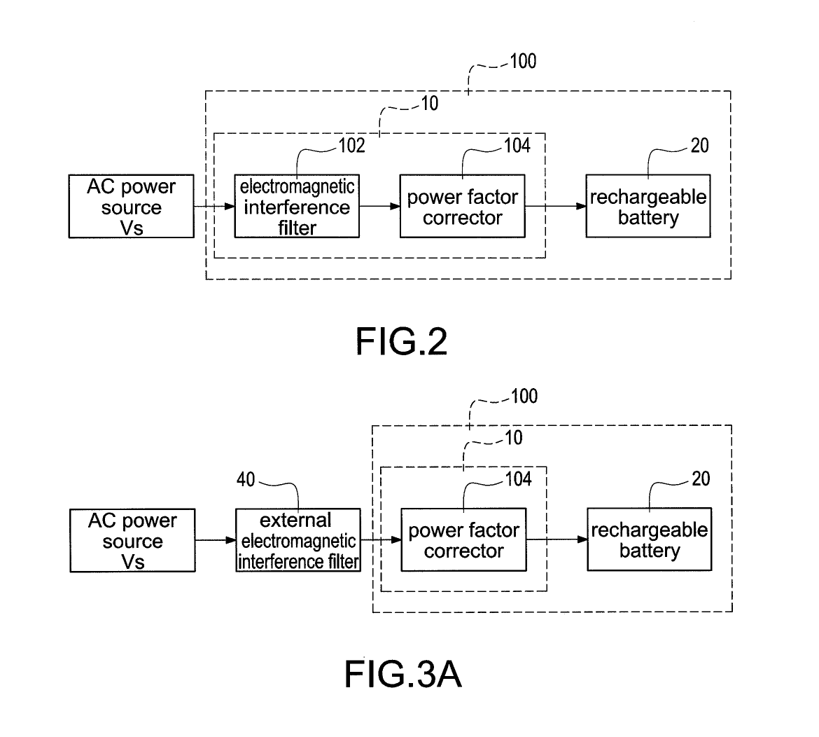

Reference is made to FIG. 2 which is a block diagram of a charging apparatus of a mobile vehicle according to a first embodiment of the present invention. The charging apparatus 10 of the mobile vehicle receives an external AC power source Vs and converts the received AC power source Vs into a DC power source (not labeled). A voltage level of the converted DC power source is transferred for providing the required voltage to charge a rechargeable battery 20 installed in the mobile vehicle 100.

The charging apparatus 10 is installed inside the mobile vehicle 100. The charging apparatus 10 includes an electromagnetic interference filter 102 and a power factor corrector 104. The electromagnetic interference filter 102 receives the AC power source Vs to eliminate the noise in the AC power source Vs. The power factor corrector 104 is electrically connected to the electromagnetic interference filter 102 to convert the filtered AC power source and output the DC power source.

In particular, the power factor corrector 104 can be a boost converter, a buck converter, a buck-boost converter, an integrated buck/boost converter, a Cuk converter, or a single ended primary inductor converter (SEPIC). Also, the power factor corrector 104 can be a bridgeless PFC.

In the first embodiment, the structure of the charging apparatus is a single-stage structure, namely, without using the DC/DC converter. The charging apparatus 10 of the mobile vehicle 100 provides a power conversion to directly provide the required DC charging voltage level to the rechargeable battery 20, thus significantly reducing the switching losses and the conduction losses, reducing the losses of the power conversion, and increasing the whole charging efficiency. Because of the single-stage structure of the charging apparatus 10, the charging apparatus 10 of the mobile vehicle 100 can provide a high-performance and low-cost design.

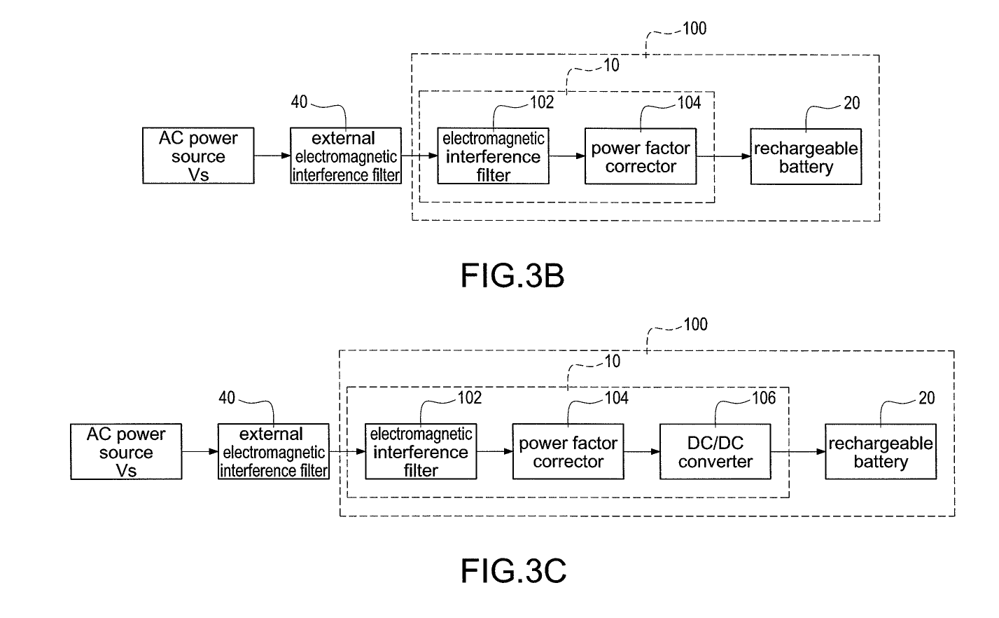

Reference is made to FIG. 3A which is a block diagram of the charging apparatus of the mobile vehicle according to a second embodiment of the present invention. The charging apparatus 10 of the mobile vehicle 100 receives an AC power source Vs filtered through an external electromagnetic interference filter 40, converts the filtered AC power source into a DC power source, and transfers a voltage level of the converted DC power source for providing the required voltage to charge a rechargeable battery 20 installed in the mobile vehicle 100. The charging apparatus 10 is installed inside the mobile vehicle 100. The charging apparatus 10 includes a power factor corrector 104. The power factor corrector 104 converts the AC power source filtered through the external electromagnetic interference filter 40 and outputs the DC power source.

In particular, the power factor corrector 104 can be a boost converter, a buck converter, a buck-boost converter, an integrated buck/boost converter, a Cuk converter, or a single ended primary inductor converter (SEPIC). Also, the power factor corrector 104 can be a bridgeless PFC.

Reference is made to FIG. 3B which is a block diagram of the charging apparatus of the mobile vehicle according to a third embodiment of the present invention. The difference between the third embodiment and the above-mentioned second embodiment is that the charging apparatus 10 further includes an electromagnetic interference filter 102. The electromagnetic interference filter 102 is electrically connected to the external electromagnetic interference filter 40 and the power factor corrector 104 to receive the AC power source Vs and eliminate the noise in the AC power source Vs.

Reference is made to FIG. 3C which is a block diagram of the charging apparatus of the mobile vehicle according to a fourth embodiment of the present invention. The difference between the fourth embodiment and the above-mentioned third embodiment is that the charging apparatus 10 further includes a DC/DC converter 106. The DC/DC converter 106 is electrically connected to the power factor corrector 104 and the rechargeable battery 20 to receive the DC power source and transfer the voltage level of the DC power source for providing the required voltage to charge the rechargeable battery 20.

In the second, third, and fourth embodiments, the external electromagnetic interference filter 40 is used to reduce external power interference to the charging apparatus 10, thus reducing the losses of the power conversion and increasing the whole charging efficiency of the charging apparatus 10 of the mobile vehicle 100. In addition, the low-cost design of the charging apparatus 10 can be achieved because the external electromagnetic interference filter 40 is installed outside the mobile vehicle 100. Furthermore, the DC/DC converter 106 provides the appropriate DC charging voltage level to the rechargeable battery 20.

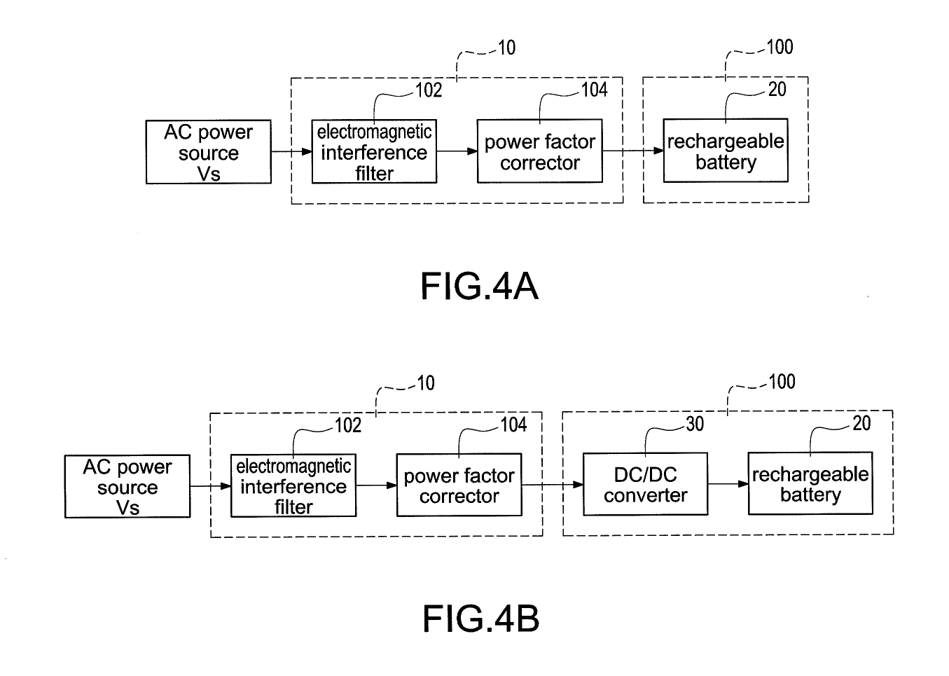

Reference is made to FIG. 4A which is a block diagram of the charging apparatus of the mobile vehicle according to a fifth embodiment of the present invention. The charging apparatus 10 of the mobile vehicle 100 receives an external AC power source Vs, converts the received AC power source Vs into a DC power source, and transfers a voltage level of the converted DC power source for providing the required voltage to charge a rechargeable battery 20 installed in the mobile vehicle 100.

The charging apparatus 10 is installed outside the mobile vehicle 100. The charging apparatus 10 includes an electromagnetic interference filter 102 and a power factor corrector 104. The electromagnetic interference filter 102 receives the AC power source Vs to eliminate the noise in the AC power source Vs. The power factor corrector 104 is electrically connected to the electromagnetic interference filter 102 to convert the filtered AC power source and output the DC power source.

In particular, the power factor corrector 104 can be a boost converter, a buck converter, a buck-boost converter, an integrated buck/boost converter, a Cuk converter, or a single ended primary inductor converter (SEPIC). Also, the power factor corrector 104 can be a bridgeless PFC.

Reference is made to FIG. 4B which is a block diagram of the charging apparatus of the mobile vehicle according to a sixth embodiment of the present invention. The difference between the sixth embodiment and the above-mentioned fifth embodiment is that the mobile vehicle 100 further includes a DC/DC converter 30. The DC/DC converter 30 is electrically connected to the power factor corrector 104 of the charging apparatus 10 to receive the DC power source and transfer the voltage level of the DC power source for providing the required voltage to charge the rechargeable battery 20.

In addition, the charging apparatus 10 of the mobile vehicle 100 further includes a vehicle controller (not shown), and the vehicle controller is installed in the mobile vehicle 100. The vehicle controller is electrically connected to the DC/DC converter 30 and the rechargeable battery 20 to control the output voltage of the DC/DC converter 30, thus providing the required DC charging voltage level to the rechargeable battery 20.

In the fifth and sixth embodiments, the charging apparatus 10 is installed outside the mobile vehicle 100. Hence, the charging apparatus 10 is only used to charge the rechargeable battery 20 when the rechargeable battery 20 needs to be charged. Accordingly, this can avoid unnecessary collision to charging apparatus 10 when the mobile vehicle 100 (such the electric vehicle or the electric motorcycle, but not limited) is driven on a bad road condition. In addition, this can prevent the charging apparatus 10 from exploding because of the high-temperature operation of the mobile vehicle 100 when the mobile vehicle 100 is driven or solarized for a long time. Furthermore, this can prevent the charging apparatus 10 from an abnormal operation because of the accumulated dirt of the mobile vehicle 100 when the mobile vehicle 100 is used but not be cleaned for years.

Accordingly, the charging apparatus 10 is installed outside the mobile vehicle 100 to increase the flexibility and reliability, increase the life span of the charging apparatus 10, and increase the traffic safety of the mobile vehicle 100.

In conclusion, the present invention has following advantages:

1. The single-stage structure of the charging apparatus 10 provides a power conversion to directly provide the required DC charging voltage level to the rechargeable battery 20, thus significantly reducing the switching losses and the conduction losses, reducing the losses of the power conversion, and increasing the whole charging efficiency;

2. The single-stage structure of the charging apparatus 10 provides the high-performance and low-cost design; and

3. The charging apparatus 10 is installed outside the mobile vehicle 100 to increase the flexibility and reliability, increase the life span of the charging apparatus 10, and increase the traffic safety of the mobile vehicle 100.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A charging apparatus of a mobile vehicle receiving an external AC power source and converting the received AC power source into a DC power source for providing the required voltage to charge a rechargeable battery installed in the mobile vehicle; the charging apparatus installed inside the mobile vehicle and the charging apparatus comprising:
an electromagnetic interference filter receiving the AC power source to eliminate the noise in the AC power source to generate a filtered AC power source; and
a power factor corrector electrically connected to the electromagnetic interference filter to convert the filtered AC power source into a DC power source and output the DC power source;
whereby the charging apparatus of the mobile vehicle provides a power conversion to directly provide the a required DC charging voltage level to the rechargeable battery, thus reducing the losses of the power conversion and increasing the whole charging efficiency.

2. The charging apparatus of claim 1, wherein the power factor corrector is a boost converter, a buck converter, a buck-boost converter, an integrated buck/boost converter, a Cuk converter, or a single ended primary inductor converter (SEPIC).

3. The charging apparatus of claim 1, wherein the power factor corrector is a bridgeless PFC.

4. A charging apparatus of a mobile vehicle receiving an external AC power source, converting the received AC power source into a DC power source, and transferring a voltage level of the converted DC power source for providing the required voltage to charge a rechargeable battery installed in the mobile vehicle; the charging apparatus installed outside the mobile vehicle and the charging apparatus comprising:
an electromagnetic interference filter receiving the AC power source to eliminate the noise in the AC power source to generate a filtered AC power source; and
a power factor corrector electrically connected to the electromagnetic interference filter to convert the filtered AC power source into a DC power source and output the DC power source;
whereby the charging apparatus is installed outside the mobile vehicle to increase the flexibility and reliability and to increase the life span of the charging apparatus.

5. The charging apparatus of claim 4, wherein the mobile vehicle further comprises a DC/DC converter, the DC/DC converter is electrically connected to the power factor corrector of the charging apparatus to receive the DC power source and transfer the voltage level of the DC power source for providing the required voltage to charge the rechargeable battery.

6. The charging apparatus of claim 4, wherein the power factor corrector is a boost converter, a buck converter, a buck-boost converter, an integrated buck/boost converter, a Cuk converter, or a single ended primary inductor converter (SEPIC).

7. The charging apparatus of claim 4, wherein the power factor corrector is a bridgeless power factor corrector (PFC).

8. A charging apparatus of a mobile vehicle receiving an AC power source filtered through an external electromagnetic interference filter, converting the filtered AC power source into a DC power source, and transferring a voltage level of the converted DC power source for providing the required voltage to charge a rechargeable battery installed in the mobile vehicle; the charging apparatus installed inside the mobile vehicle and the charging apparatus comprising:
a power factor corrector converting the filtered AC power source filtered through the external electromagnetic interference filter and outputting the DC power source;
whereby the charging apparatus of the mobile vehicle provides a power conversion to directly provide the required DC charging voltage level to the rechargeable battery, thus reducing the losses of the power conversion and increasing the whole charging efficiency.

9. The charging apparatus of claim 8, wherein the mobile vehicle further comprises an electromagnetic interference filter, the electromagnetic interference filter is electrically connected to the external electromagnetic interference filter and the power factor corrector to receive the AC power source and eliminate the noise in the AC power source.

10. The charging apparatus of claim 8, wherein the mobile vehicle further comprises a DC/DC converter, the DC/DC converter is electrically connected to the power factor corrector and the rechargeable battery to receive the DC power source and transfer the voltage level of the DC power source for providing the required voltage to charge the rechargeable battery.

11. The charging apparatus of claim 8, wherein the power factor corrector is a boost converter, a buck converter, a buck-boost converter, an integrated buck/boost converter, a Cuk converter, or a single ended primary inductor converter (SEPIC).

12. The charging apparatus of claim 8, wherein the power factor corrector is a bridgeless power factor corrector (PFC).
